(19) United States
(12) Patent Application Publication
(10) Pub. No.: US 2025/0317756 A1
(43) Pub. Date: Oct. 9, 2025

(54) CONDITIONAL NEURAL NETWORKS FOR CELLULAR COMMUNICATION SYSTEMS

(71) Applicant: GOOGLE LLC, Mountain View, CA (US)

(72) Inventors: Jibing Wang, San Jose, CA (US); Erik Richard Stauffer, Sunnyvale, CA (US)

(21) Appl. No.: 18/863,276

(22) PCT Filed: May 10, 2023
(86) PCT No.: PCT/US2023/021686

§ 371 Date: Nov. 5, 2024

Related U.S. Application Data
(60) Provisional application No. 63/341,736, filed on May 13, 2022.

(51) Int. Cl. H04W 24/02

(52) U.S. Cl. CPC H04W 24/02

(57) ABSTRACT

A wireless communication system employs conditional neural networks (CNNs) 114 to provide for one or more wireless communication techniques. A cellular user equipment (UE) of the wireless communication system obtains a CNN configuration and a CNN execution condition. The UE monitors for the CNN execution condition. The UE, responsive to determining the CNN execution condition has been satisfied, configures and implements a CNN based on the CNN configuration. The UE performs a set of wireless communication operations using the configured CNN.

### BACKGROUND

In conventional wireless communication systems, a user equipment (UE) device employs transmitter and receiver processing paths with complex functionality to perform wireless communication operations, such as radio frequency (RF) signaling, channel estimation, cell measurement, beam management, and so on. Typically, engineers design, test, and implement each process block in a processing path relatively separate from each other. Later, engineers integrate the processing path of blocks and perform further testing and adjustment of the blocks. However, in at least some configurations, a UE mitigates much of the design, test, and implementation efforts for a transmitting processing path or receiving processing path through the use of a neural network, such as a deep neural network (DNN), in place of some or all of the individual blocks of a processing path. In this approach, one or more network components, such as a base station (BS), train the neural networks implemented at the UE's transmitting and receiving processing paths to provide similar functionality as one or more conventional individual processing blocks in the corresponding path. Moreover, these neural networks can be dynamically reconfigured during operation by, for example, modifying coefficients, layer sizes and connections, kernel sizes, and other parameter configurations to adapt to changing operating conditions.

### SUMMARY OF EMBODIMENTS

In accordance with some embodiments, a computer-implemented method, in a user equipment (UE) device of a cellular communication system, includes obtaining a first conditional neural network configuration and a first conditional neural network execution condition; monitoring for the first conditional neural network execution condition; responsive to determining the first conditional neural network execution condition has been satisfied, configuring, based on the first conditional neural network configuration, a first neural network implemented at the UE; and performing a first set of wireless communication operations using the configured first neural network.

In various embodiments, this method further can include one or more of the following aspects: obtaining a second conditional neural network configuration; monitoring for a second conditional neural network execution condition; responsive to determining the second conditional neural network execution condition has been satisfied, configuring, based on the second conditional neural network configuration, a second neural network implemented at the UE; and performing a second set wireless communication operations using the configured second neural network, wherein the second set of wireless communication operations is different from the first set of wireless communication operations; implementing the configured second neural network concurrently with the configured first neural network; wherein configuring the second neural network comprises configuring at least one of an architecture of the second neural network, one or more weights of the second neural network, or one or more biases of the second neural network; monitoring for the first conditional neural network execution condition comprising of two or more operating conditions; and responsive to determining the first conditional neural network execution condition has been satisfied, configuring the first neural network implemented based on the first conditional neural network configuration.

In various embodiments, obtaining the first conditional neural network configuration includes receiving, from a network component of the cellular communication system, an index associated with the first conditional neural network configuration; and obtaining the first conditional neural network configuration from a storage structure using the index.

In various embodiments, configuring the first neural network includes executing a timer based on timer information received from a network component of the cellular communication system; and responsive to the timer expiring, configuring the first neural network based on the first conditional neural network configuration.

In accordance with some embodiments, a computer-implemented method, in a managing infrastructure component of a cellular communication system, includes transmitting a conditional neural network configuration to a user equipment (UE) of the cellular communication system; and transmitting a set of conditional neural network execution conditions to the UE.

In various embodiments, transmitting the conditional neural network configuration includes one or more of transmitting the conditional neural network configuration to the UE in a Radio Resource Control (RRC) message; or transmitting the conditional neural network configuration to the UE in a System Information Block (SIB message.

In various embodiments, transmitting the set of conditional neural network execution conditions one or more of transmitting the set of conditional neural network execution conditions to the UE in a System Information Block (SIB) message; or transmitting the set of conditional neural network execution conditions as part of the conditional neural network configuration.

In accordance with some embodiments, a device includes a radio frequency (RF) antenna interface; at least one processor coupled to the RF antenna interface; and a memory storing executable instructions, the executable instructions configured to manipulate the at least one processor to perform any of the methods described above and herein.

### BRIEF DESCRIPTION OF THE DRAWINGS

The present disclosure is better understood and its numerous features and advantages are made apparent to those skilled in the art by referencing the accompanying drawings. The use of the same reference symbols in different drawings indicates similar or identical items.

FIG. 1 is a diagram illustrating an example wireless system employing a conditional neural network architecture for performing one or more wireless communication operations in accordance with some embodiments.

FIG. 2 is a table illustrating an example of a storage structure for storing conditional neural network configurations in accordance with some embodiments.

FIG. 3 is a table illustrating another example of the storage structure of FIG. 2 in which the storage structure implements indices in accordance with some embodiments.

FIG. 4 is a table illustrating an example of a storage structure for storing conditional neural network architecture configurations in accordance with some embodiments.

FIG. 5 is a table illustrating an example of a storage structure for storing conditional neural network weight configurations in accordance with some embodiments.

FIG. 6 is a table illustrating an example of a storage structure for storing conditional neural network bias configurations in accordance with some embodiments.

FIG. 7 is a diagram illustrating a machine learning (ML) module for employing conditional neural networks in accordance with some embodiments.

FIG. 8 and FIG. 9 are flow diagrams together illustrating an example method for implementing conditional neural networks in a wireless system in accordance with some embodiments.

FIG. 10 is a ladder signaling diagram for implementing conditional neural networks in a wireless system and illustrates example operations of the method of FIG. 8 and FIG. 9 in accordance with some embodiments.

FIG. 11 is a diagram illustrating example hardware configuration of a user equipment of the wireless system of FIG. 1 in accordance with some embodiments.

FIG. 12 is a diagram illustrating example hardware configuration of a base station of the wireless system of FIG. 1 in accordance with some embodiments.

FIG. 13 is a diagram illustrating an example hardware configuration of a managing infrastructure component of the wireless system of FIG. 1 in accordance with some embodiments.

### DETAILED DESCRIPTION

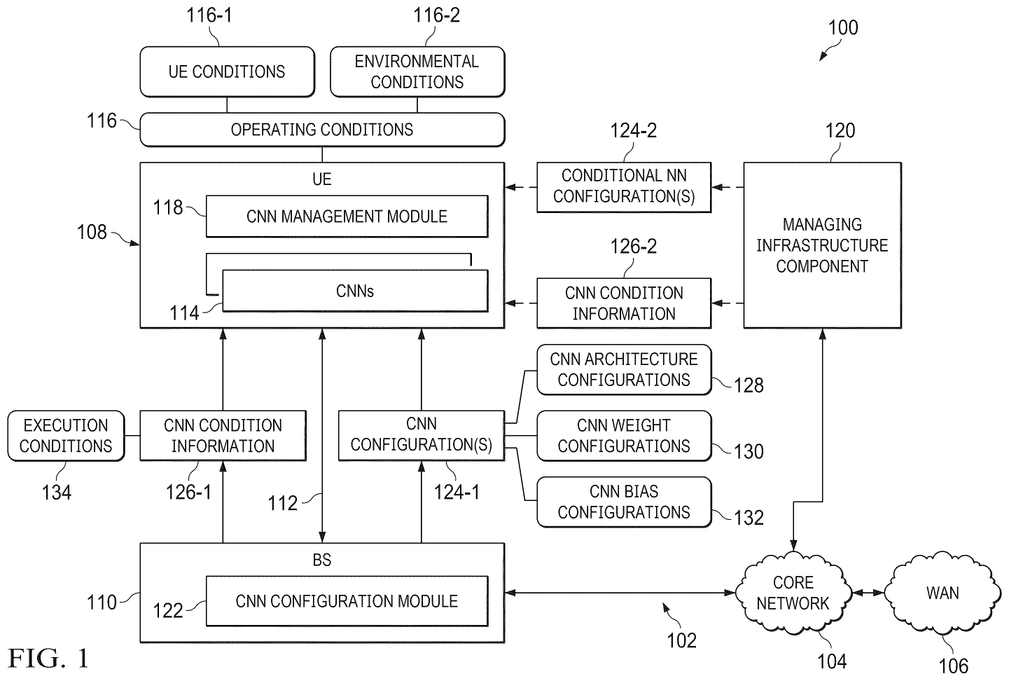

FIG. 1 illustrates a wireless communications system 100 employing conditional neural networks (CNNs) in accordance with some embodiments. As depicted, the wireless communication system 100 is a cellular network that is coupled to a network infrastructure 102 including, for example, a core network 104, one or more wide area networks (WANs) 106 or other packet data networks (PDNs), such as the Internet, a combination thereof, or the like. The wireless communications system 100 further includes one or more UEs 108 and one or more BSs 110. Each BS 110 supports wireless communication with one or more UEs 108 through one or more wireless communication links 112, which can be unidirectional or bi-directional. In at least some embodiments, each BS 110 is configured to communicate with the UE 108 through the wireless communication links 112 via radio frequency (RF) signaling using one or more applicable RATs as specified by one or more communications protocols or standards. As such, each BS 110 operates as a wireless interface between the UE 108 and various networks and services provided by the core network 104 and other networks, such as packet-switched (PS) data services, circuit-switched (CS) services, and the like. Conventionally, communication of data or signaling from a BS 110 to the UE 108 is referred to as “downlink” (DL), whereas communication of data or signaling from the UE 108 to a BS 110 is referred to as “uplink” (UL). In at least some embodiments, a BS 110 also includes an inter-base station interface, such as an Xn and/or X2 interface, configured to exchange user-plane and control-plane data between another BS 110.

Each BS 110 can employ any of a variety or combination of RATs, such as operating as a NodeB (or base transceiver station (BTS)) for a Universal Mobile Telecommunications System (UMTS) RAT (also known as “3G”), operating as an enhanced NodeB (eNodeB) for a Third Generation Partnership Project (3GPP) Long Term Evolution (LTE) RAT, operating as a 5G node B (“gNB”) for a 3GPP Fifth Generation (5G) New Radio (NR) RAT, and the like. Each BS 110 can be an integrated base station or a distributed base station with a Central Unit (CU) and one or more Distributed Units (DU). The UE 108, in tum, can implement any of a variety of electronic devices operable to communicate with the BS 110 via a suitable RAT. including, for example, a mobile cellular phone, a cellular-enabled tablet computer or laptop computer, a desktop computer, a cellular-enabled video game system, a server, a cellular-enabled appliance, a cellular-enabled automotive communications system, a cellular-enabled smartwatch or other wearable device, and the like.

In at least some embodiments, UEs 108 implement one or more neural networks (NNs) to replace the functionality conventionally implemented by separate hard-coded designs. For example, transmission (TX) and receiving (RX) processing modules of the UE implement one or more neural networks to provide transmission/reception functionality, such as coding and decoding, modulation and demodulation, channel estimation, cell measurement, beam management, Random Access Channel (RACH) procedures, data retransmission, transmission feedback, data streaming, and so on. Although neural networks advantageously replace the functionality conventionally implemented by separate hard-coded designs, changes in operating conditions of the UE 108 or its environment can render a neural network inoperable or unsuitable for the present conditions. In these situations, the BS 110 or other network component performs signaling operations with the UE 108 to change or reconfigure the neural networks implemented by the UE 108. However, the BS 110 can incur significant signaling overhead when tracking the UE 108 and changing/reconfiguring neural network architectures, weights, and biases at the UE 108

As such, in at least some embodiments, the neural networks implemented by the UE 108 are conditional neural networks (CNNs) 114 to ensure the most suitable neural network is implemented at the UE 108 for the present operating conditions without the UE 108 or BS 110 incurring the significant signaling overhead experienced with conventional neural network management mechanisms. A CNN refers to a neural network, such as a deep neural network (DNN), that is associated with at least one of a specific neural network architecture configuration, neural network weight configuration, or neural network bias configuration implemented by the UE 108 upon detection of a particular operating condition(s) (or event) 116 associated with the UE 108. The operating conditions 116 are conditions/events, such as UE conditions 116-1 and environmental conditions 116-2, affecting at least one of the reception or transmission of wireless signals by the UE 108. Examples of UE conditions 116-1 include UE thermal conditions, UE battery conditions, UE location/position, UE pose/orientation, UE capabilities, and so on. Examples of environmental conditions 116-2 include air interface conditions such as UE RF signal strength, serving BS RF signal strength, neighboring BSs RF signal strength, channel-specific parameters/conditions, propagation-path characteristics, and so on. Other examples of operating conditions 116 include when the signal quality of the serving cell falls below a certain threshold, when the measurement of neighbor cell falls below or above a certain threshold, when the signal quality of another cell is above a certain threshold, a combination thereof, and so on.

The UE 108, in at least some embodiments, comprises a CNN management module 118 configured to adaptively and dynamically implement CNNs 114 at the UE 108 based on changes in the operating conditions 116 associated with the UE 108. For example, the CNN management module 118 monitors for a specific operating condition(s) 116 and implements a given CNN(s) 114 associated with the operating condition(s) 116 when the operating condition(s) 116 occurs. In at least some embodiments, implementing a given CNN 114 includes configuring a neural network presently implemented at the UE 108 with at least one of different neural network weights or different neural network biases, or switching to a new CNN 114 having a fully (or completely) different neural network architecture. The CNN management module 118, in at least some embodiments, is configured to concurrently monitor for multiple different operating conditions 116 associated with different CNNs 114. For example, the CNN management module 118 can concurrently monitor an operating condition(s) 116 associated with CNNs 114 for performing channel estimation and an operation condition(s) 116 associated with CNNs 114 for performing beam management. As such, the CNN management module 118, in at least some embodiments, concurrently implements multiple CNNs 114 for different operations/processes performed by the UE 108.

In at least some embodiments, the serving BS 110 of the UE 108 or another network component, such as a managing infrastructure component 120 (“managing component 120” for brevity), manages the conditions and configurations associated with the CNNs 114. For example, at least one of the BS 110 or managing component 120 comprises a CNN configuration module 122 that transmits CNN configurations 124 (illustrated as CNN configuration(s) 124-1 and CNN configuration(s) 124-2) and CNN condition information 126 (illustrated as CNN condition information 126-1 and CNN condition information 126-2) to the UE 108. The CNN configurations 124 include, for example, one or more neural network architecture configurations 128 (e.g., number of layers, weights, and biases), one or more neural network weight configurations 130, one or more neural network bias configurations 132, or a combination thereof. As such, a given CNN configuration 124 indicates to the UE 108 whether the UE 108 is to switch to a fully (or completely) different neural network architecture or maintain the presently implemented neural network architecture but change one or both of the neural network weights or neural network biases.

The CNN condition information 126 includes execution condition(s) 134 associated with one or more CNN configurations 124. As described in greater detail below, a CNN execution condition 134 indicates one or more operating conditions 116, such as UE conditions 116-1 or environmental conditions 116-2, that act as a trigger for the CNN management module 118 to apply the corresponding CNN configuration(s) information 124. The execution conditions 134 can be associated with periodic events (e.g., events that repeat at specific time intervals), aperiodic events (e.g., events that do not necessarily repeat after a specific time interval or that are triggered after a predefined event occurs), or a combination thereof. Examples of execution conditions 134 include the signal quality of a serving cell falling below a signal quality threshold, a cell measurement of a neighbor cell falling below or above a cell measurement threshold, the signal quality of another cell being above a signal quality threshold, a combination thereof, and so on.

In some instances, the BS 110 transmits a CNN configuration 124 and corresponding CNN condition information 126 to the UE 108 via a control message, such as a Radio Resource Control (RRC) message(s) or System Information Block (SIB) message(s). However, other mechanisms for transmitting this information are applicable as well. Also, in some instances, the BS 110 transmits the CNN condition information 126 separate from the CNN configurations 124. The BS 110 transmits the CNN configuration information 124 and CNN condition information 126 to the UE 108 at various points in time, including when the UE 108 and BS 110 establish a wireless connection, such as via a 5G NR stand-alone (SA) registration/attach process in a cellular context or via an IEEE 802.11 association process in a wireless local area network (WLAN) context, when the UE 108 moves into the BS cell while in idle mode, during handover, during secondary cell (or node) addition or change, and so on.

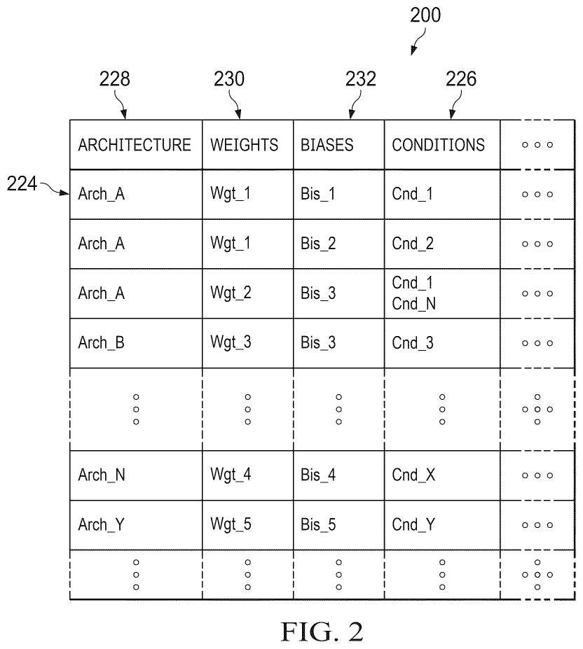

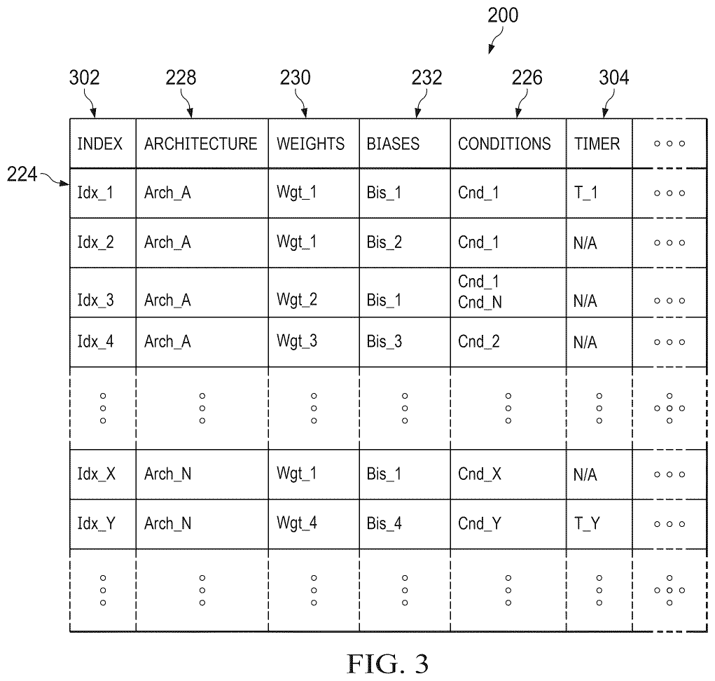

The UE 108, in at least some embodiments, maintains one or more of the CNN configurations 124 or the CNN condition information 126 in a storage structure 200 (FIG. 2), such as a lookup table. In at least some embodiments, the UE 108 stores the CNN configurations 124 and CNN condition information 126 in the storage structure 200 as the UE 108 receives this information. Alternatively, the BS 110 or another network component preconfigures the storage structure 200 with CNN configurations 124 and CNN condition information 126. As such, when the BS 110 wants the UE 108 to apply a given CNN configuration 124 or monitor for a given CNN execution condition(s) 134, the BS 110 sends an index (e.g., a unique value) 302 (FIG. 3) to the UE 108 associated with the CNN configuration(s) 124 or execution condition(s) 134. In at least some embodiments, the CNN management module 118 uses the index 302 to look up the corresponding CNN configuration(s) 124 or execution condition(s) 134 in the storage structure 200.

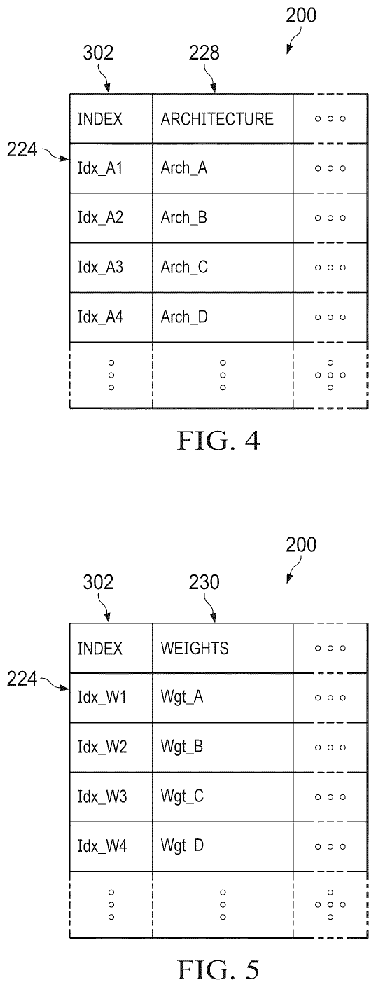

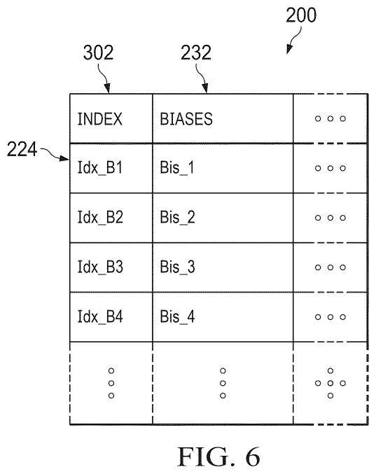

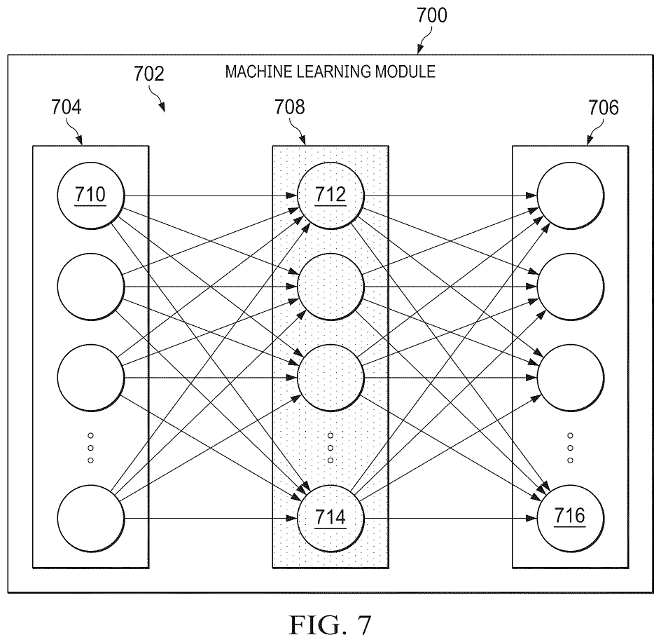

FIG. 2 to FIG. 6 show various examples of the storage structure 200 implemented by the UE 108 for maintaining the CNN configurations 124 and CNN condition information 126. In at least some of these examples, the storage structure 200 is a lookup table (LUT), but other storage structures are also applicable. In the example shown in FIG. 2, the storage structure 200 comprises a first column including architecture configuration information 228, a second column including weight information 230, a third column including bias information 232, and a fourth column including CNN condition information 226. Each row 224 of the storage structure 200 represents a given CNN configuration 124. The architecture configuration information 228 indicates a given neural network architecture (e.g., number of layers, number of nodes, etc.) for implementation by the UE 108 for the CNN configuration 124. The weight information 230 indicates the weights to be implemented by the UE 108 for the CNN configuration 124. The bias information 232 indicates the biases to be implemented by the UE 108 for the CNN configuration 124. The CNN condition information 226 indicates one or more CNN execution conditions 134 that are to occur (or be satisfied) for the UE 108 to implement the CNN configuration 124. For example, when the CNN management module 118 of the UE 108 detects that execution condition Cnd_1 (e.g., the signal power of the serving cell dropping below a signal power threshold) has occurred, the CNN management module 118 implements a CNN 114 having the architecture Arch_A, weights Wgt_1, and biases Bis_1. The storage structure 200 does not include at least one of the second or third columns in other configurations. In these configurations, the CNN configurations information 226 includes one or more of the corresponding weight information 230 or the bias information 232.

The CNN management module 118, in at least some embodiments, uses a detected execution condition(s) 134 as an index to look up the corresponding CNN configuration 124 to implement at the UE 108. However, in other embodiments, as shown in FIG. 3, one or more of the CNN configurations 124 or CNN condition information 226 are stored with a unique index 302 in the storage structure 200. In this example, the CNN management module 118 uses the index 302 to identify one or more CNN configurations 124 to implement, one or more CNN execution conditions 134 to monitor, or a combination thereof. For example, when the BS 110 (or another network component) wants the UE 108 to implement a given CNN(s) 114, the BS 110 transmits the corresponding index(s) 302 to the UE 108. The CNN management module 118 of the UE 108 uses the received index(s) 302 to lookup the corresponding CNN configuration 124 maintained in the storage structure 200 and the associated CNN condition information 226.

In at least some embodiments, the UE 108 also stores timer information associated with one or more CNN configurations 124, as shown in FIG. 3. For example, FIG. 3 shows that the storage structure 200 comprises a sixth column including timer information 304 associated with at least one CNN configuration 124. In at least some embodiments, the UE 108 receives the timer information 304 from the BS 110 as part of, or separate from, CNN configurations 124 and CNN condition information 126. The BS 110 transmits the timer information 304 to the UE 108 via, for example, an RRC message(s), a SIB message(s), or the like. The timer information 304 indicates to the UE 108 a given time interval that the UE 108 is to wait before implementing the corresponding CNN configuration 124 after detection/satisfaction of the associated execution conditions 134. For example, when the UE 108 determines that an execution condition 134 has been detected/satisfied, the UE 108 executes a (hysteresis) timer based on the timer information 304 received from the BS 110. Based on the expiration of the timer, the UE applies the associated CNN configuration(s) 124.

In at least some embodiments, two or more of the architecture configuration information 228, weight information 230, bias information 232, CNN condition information 226, and timer information 304 are maintained separately from each other along with their associated indices 302 in the same or different storage structure 200, as shown in the examples of FIG. 3 to FIG. 6. In these examples, the BS 110 separately indicates one or more of a CNN architecture 228, weight information 230, bias information 232, timer information 304, or CNN condition information 226 to the UE 108 by transmitting their associated index 302 to the UE 108. As such, the BS 110 can efficiently change one or more parameters/characteristics of a CNN 114 by transmitting one or more indices 302 to the UE 108.

The CNNs 114 implemented by the UE 108, in at least some embodiments, are individually trained or jointly trained to facilitate the overall associated process, such as channel estimation, RACH procedures, and so on. In at least some embodiments, the managing component 120 manages the training, selection, and maintenance of these CNNs 114. The managing component 120 can include, for example, a server or other component within the network infrastructure 102 of the wireless communication system 100. The managing component 120 can also include a component external to the wireless communication system 100, such as a cloud server or other computing device. Further, although depicted in the illustrated example as a separate component, the BS 110, in at least some embodiments, implements the managing component 120. The oversight functions provided by the managing component 120 can include, for example, some or all of overseeing the training of the neural networks, managing the selection of CNN configurations 124 associated with the UE 108 based on specific capabilities or other component-specific parameters of the UE 108, receiving and processing capability updates for purposes of CNN configuration selection, receiving and processing feedback for purposes of CNN training or selection, and the like. In the context of the managing component 120, CNN configuration selection refers to the selection of CNN configurations 124 that the managing component 120 (or BS 110) makes available to the UE 108. The UE 108 subsequently implements one or more of these CNN configurations 124 when execution conditions 134 associated with the CNN configurations 124 are detected by the UE 108.

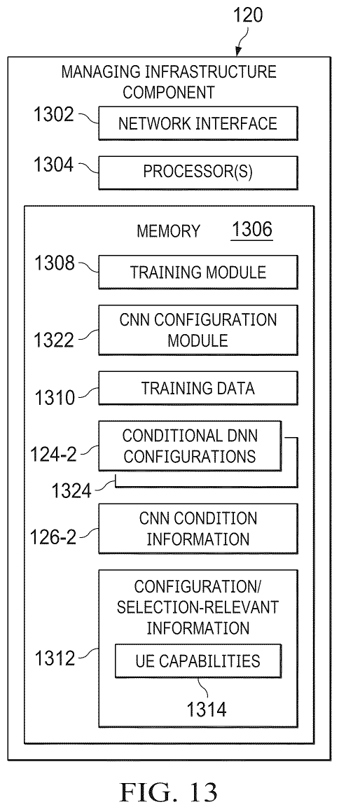

As described below in more detail with respect to FIG. 13, the managing component 120, in some embodiments, maintains a set of candidate CNN configurations 1324. The managing component 120 (or another network component) selects CNN configurations 124-2 from the set of candidate CNN configurations 1324 to be made available to the UE 108 based at least in part on the capabilities of the UE 108, the capabilities of other components in the transmission chain, the capabilities of other components in the receiving chain or a combination thereof. These capabilities can include, for example, sensor capabilities, processing resource capabilities, battery/power capabilities, RF antenna capabilities, capabilities of one or more accessories of the UE 109 (or another network component), and so on. The information representing these capabilities for the UE 108 is obtained by and stored at the managing component 120 as expanded UE capability information 1314 (FIG. 13). In at least some embodiments, the managing component 120 further considers parameters or other aspects of the channels in the environment, such as the carrier frequency of the channel, the known presence of objects or other interferers, and the like.

In support of this approach, in some embodiments, the managing component 120 can manage the training of different individual candidate CNN configurations 124-2 or joint training of different combinations of candidate CNN configurations 124-2 for different capability/context combinations. The managing component 120 then can obtain capability information 1314 from the UE 108, and from this capability information, the managing component 120 selects CNN configurations 124-2 from the set of candidate CNN configurations 1324 for the UE 108 at least based in part on the corresponding indicated capabilities, RF signaling environment, and the like. In at least some embodiments, the managing component 120 (or another network component) jointly trains the candidate CNN configurations 124-2 as paired subsets, such that each candidate CNN configuration 124-2 for a particular capability set for the UE 108 is jointly trained with a single corresponding candidate CNN configuration 124-2 for a particular capability set of another network component, such as the serving or neighboring BS 110. In other embodiments, the managing component 120 (or another network component) trains the candidate CNN configurations 124-2 such that each candidate configuration 124-2 for the UE 108 has a one-to-many correspondence with multiple candidate configurations for the other network component and vice versa.

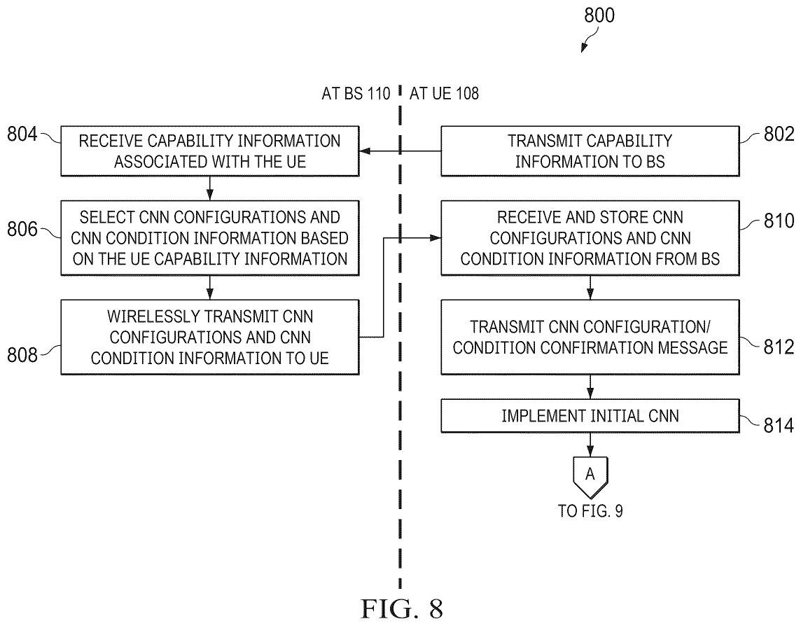

FIG. 7 illustrates an example machine learning (ML) module 700 of the UE 108 for implementing a CNN 114 in accordance with some embodiments. In the depicted example, the ML module 700 implements a plurality of CNNs 114, such as CDNNs, with groups of connected nodes (e.g., neurons and/or perceptrons) organized into three or more layers. The nodes between layers are configurable in a variety of ways, such as a partially connected configuration where a first subset of nodes in a first layer is connected with a second subset of nodes in a second layer, a fully connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based upon adaptive learning. Using the CNN 114, the ML module 700 performs a variety of different types of analysis, including single linear regression, multiple linear regression, logistic regression, stepwise regression, binary classification, multiclass classification, multivariate adaptive regression splines, locally estimated scatterplot smoothing, and so forth.

In some implementations, the ML module 700 adaptively learns based on supervised learning. In supervised learning, the ML module 700 receives various types of input data as training data. The ML module 700 processes the training data to learn how to map the input to a desired output. As one example, the ML module 700 receives configuration information for one or more processes (e.g., channel estimation, RACH, beam management, etc.), UE sensor data or related information, capability information of the UE 108, capability information of BSs 110, operating environment characteristics of the UE 108, operating environment characteristics of BSs 110, representations of received signals, or the like as input and learns how to map this input training data to, for example, one or more configured outputs (e.g., channel estimations, RACH signals, etc.). In at least some embodiments, the training can include using sensor data as input, capability information as input, RF antenna configuration or other operational parameter information as input, and the like.

During a training procedure, the ML module 700 uses labeled or known data as input to the CNN 114. The CNN 114 analyzes the input using the nodes and generates a corresponding output. The ML module 700 compares the corresponding output to truth data and adapts the algorithms implemented by the nodes to improve the accuracy of the output data. Afterward, the CNN 114 applies the adapted algorithms to unlabeled input data to generate corresponding output data. The ML module 700 uses one or both of statistical analysis and adaptive learning to map an input to an output. For instance, the ML module 700 uses characteristics learned from training data to correlate an unknown input to an output that is statistically likely within a threshold range or value. This allows the ML module 700 to receive complex input and identify a corresponding output. In some implementations, a training process trains the ML module 700 on characteristics of communications transmitted over a wireless communication system (e.g., time/frequency interleaving, time/frequency deinterleaving, convolutional encoding, convolutional decoding, power levels, channel equalization, inter-symbol interference, quadrature amplitude modulation/demodulation, frequency-division multiplexing/de-multiplexing, transmission channel characteristics) concurrent with characteristics of data encoding/decoding schemes employed in such systems. This allows the trained ML module 700 to receive samples of a signal as an input and recover information from the signal, such as the binary data embedded in the signal.

In the depicted example, the CNN 114 includes an input layer 702, an output layer 704, and one or more hidden layers 706 positioned between the input layer 702 and the output layer 704. Each layer has an arbitrary number of nodes, where the number of nodes between layers can be the same or different. That is, the input layer 702 can have the same number and/or a different number of nodes as output layer 704, the output layer 704 can have the same number and/or a different number of nodes than the one or more hidden layer 706, and so forth.

Node 708 corresponds to one of several nodes included in input layer 702, wherein the nodes perform separate, independent computations. A node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 708 can determine whether to pass the processed input data to one or both of node 710 and node 712 of hidden layer 706. Alternatively or additionally, node 708 passes the processed input data to nodes based upon a layer connection architecture. This process can repeat throughout multiple layers until the CNN 114 generates an output using the nodes (e.g., node 714) of output layer 704.

A CNN 114 can also employ a variety of architectures that determine what nodes within the CNN 114 are connected, how data is advanced and/or retained in the neural network, what weights and coefficients the neural network is to use for processing the input data, how the data is processed, and so forth. These various factors collectively describe a CNN architecture configuration, such as the CNN configurations 124 briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a CNN architecture configuration 1124 can include a variety of parameter configurations that influence how the CNN 114 or other neural network processes input data.

In at least some embodiments, a CNN configuration 124 of a CNN 114 is characterized by various architecture configurations, parameter configurations, or a combination thereof. To illustrate, consider an example in which the CNN 114 implements a convolutional neural network. Generally, a convolutional neural network corresponds to a type of DNN in which the layers process data using convolutional operations to filter the input data. Accordingly, the convolutional neural network architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer and using the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 704) to every node in a second layer (e.g., hidden layer 706), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a CNN 114 consistent with the guidelines provided herein. Accordingly, a neural network architecture configuration can include any suitable type of configuration parameter that a CNN 114 can apply that influences how the CNN 114 processes input data to generate output data.

The CNN configurations 124 implemented by the ML module 700, in at least some embodiments, are based on capabilities (including sensors) of the node implementing the ML module 700, of at least one node that is upstream or downstream of the node implementing the ML module 700, or a combination thereof. For example, the UE 108 has one or more sensors enabled or disabled or has battery power limited. Thus, in this example, the ML module 700 for the UE 108 is trained based on different sensor configurations of a UE 108 or battery power as an input to facilitate, for example, the ML module 700 at the UE 108 to employ techniques that are better suited to different sensor configurations of the UE 108 or lower power consumption. Accordingly, in some embodiments, the device implementing the ML module 700 is configured to implement different CNN configurations 124 for different combinations of capability parameters, sensor parameters, RF environment parameters, operational parameters, other UE conditions 116-1, other environmental conditions 116-2, or a combination thereof. For example, the UE 108 has access to one or more CNN configurations 124 for use depending on the present state of the UE battery of the UE 108.

To facilitate the process of selecting appropriate individual CNN configurations 124 for potential implementation by the UE 108, the managing component 120, in at least some embodiments, trains the ML module(s) 700 implemented by the UE 108 using a suitable combination of neural network management modules and training modules. The training can occur offline when no active communication exchanges are occurring or online during active communication exchanges. For example, the managing component 120 can mathematically generate training data, access files that store the training data, obtain real-world communications data, etc. The managing component 120 then extracts and stores the various learned CNN configurations 124 for subsequent use. Some implementations store input characteristics with each CNN configuration 124, whereby the input characteristics describe various properties of the UE 108 operating characteristics and capability configuration corresponding to the respective CNN configurations 124.

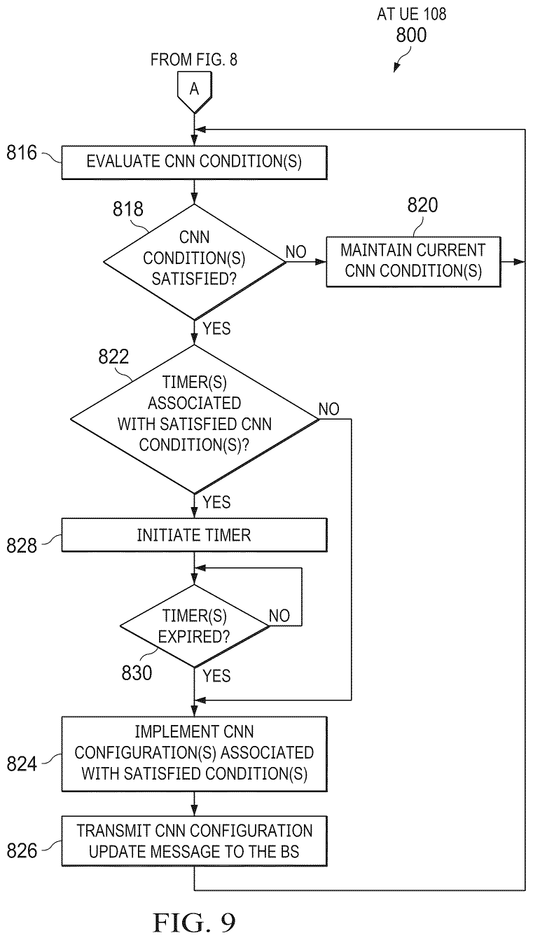

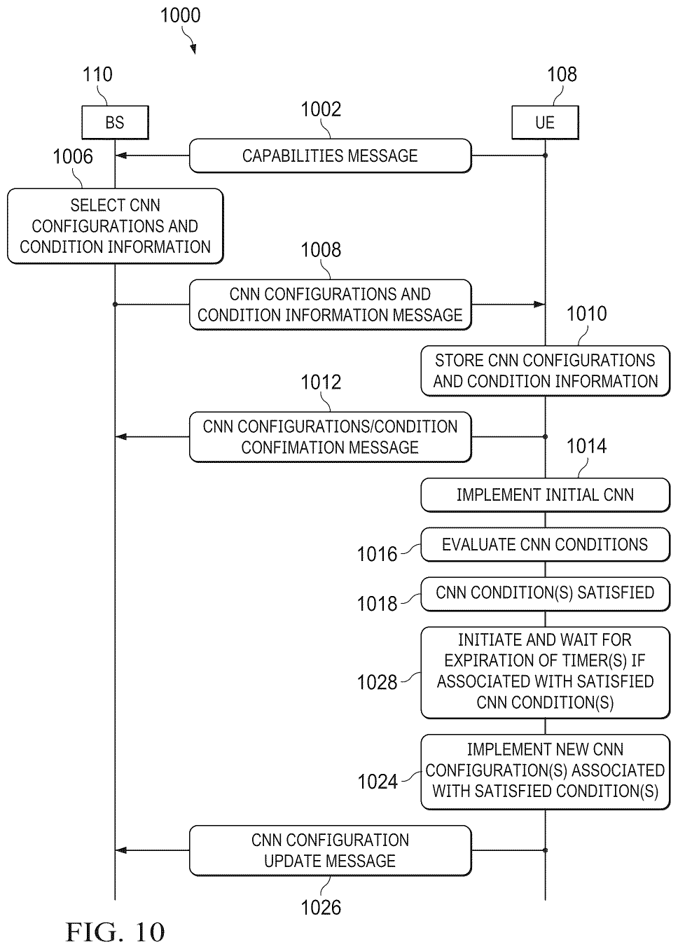

FIG. 8 to FIG. 10 together illustrate an example method 800 for adaptively and dynamically implementing CNNs at a UE 108 in accordance with some embodiments. For ease of discussion, the processes of method 800 are described with reference to the example transaction (ladder) diagram 1000 of FIG. 10. Also, although FIG. 8 to FIG. 10 illustrate a BS 110 as performing one or more of the described operations/processes, the managing component 120 or another network component can perform at least one of these processes/operations.

In at least some embodiments, method 800 initiates at block 802 with the UE 108 transmitting a capabilities message 1002 (FIG. 10) comprising capabilities information to the BS (or managing component 120). For example, the capabilities message 1002 can indicate the sensor capabilities, processing resource capabilities, battery/power capabilities, RF antenna capabilities, capabilities of one or more accessories of the UE 108, and the like. At block 804, the BS receives the capabilities message 1002 from the UE 108. In at least some embodiments, the BS 110 obtains UE capability information from the managing component 120 instead of, or in addition to, the UE 108. In other embodiments, the BS 110 is already informed of the capabilities of the UE 108, in which case the BS 110 accesses a local or remote database or other data store for this information. In at least some embodiments, the BS 110 sends a capabilities request to the UE 108. For example, the BS 110 sends a UECapabilityEnquiry RRC message, which the UE 108 responds to with a UECapabilityInformation RRC message that contains the relevant capability information. In at least some embodiments, the BS 110 transmits the UE capability information to the managing component 120.

At block 806, the CNN configuration module 122 of the BS 110 selects 1006 (FIG. 10) one or more CNN configurations 124 and associated CNN condition information 126 for the UE 108. In at least some embodiments, the CNN configuration module 122 selects one or more of the CNN configurations 124 or CNN condition information 126 based on the UE capability information received from the UE 108. For example, the CNN configuration module 122 employs an algorithmic selection process that compares the capability information obtained from the UE 108 to the attributes of CNN configurations in the set of candidate CNN configurations 1324 to identify suitable CNN configurations 124 and associated CNN condition information 126.

At block 808, the BS 110 wirelessly transmits a message 1008 (FIG. 10) comprising CNN configuration(s) and condition information to the UE 108. For example, the BS 110 transmits a Layer 1 signal, a Layer 2 control element, a Layer 3 RRC message, a combination thereof, or the like comprising information representing the selected CNN configuration(s) 124 and CNN condition information 126. In other embodiments, the BS 110 transmits the selected CNN configuration(s) 124 and CNN condition information 126 separate from each other. At block 810, the UE 108 receives the message 1008 from the BS 110 and stores the CNN configuration(s) 124 and CNN condition information 126 included therein. The CNN management module 118, in at least some embodiments, stores the CNN configuration(s) 124 and CNN condition information 126 in a storage structure 200, such as that described above with respect to FIG. 2 to FIG. 6. At block 812, the UE 108 generates and transmits a CNN configuration/condition confirmation message 1012 (FIG. 10) to the BS 110, indicating that the UE 108 successfully received the contents of the message 1008.

If the BS 110 (or another network component) preconfigures the UE 108 with one or more of the CNN configuration(s) 124 or CNN condition information 126, one or more of the processes illustrated in blocks 802 to 812 are adjusted or are not performed. For example, instead of transmitting the message 1008 at block 808. the BS 110 transmits a message(s) comprising one or more indices 302 to the UE 108. As described above with respect to FIG. 3, the UE 108 uses a received index 302 to lookup and identify one or more of a corresponding neural network architecture(s) 128, neural network weight(s) 130, or neural network bias(es) 132 to implement and execution condition(s) 134 to monitor.

At block 814, the CNN management module 118 of the UE 108 implements one or more initial neural networks 1014 (FIG. 10), such as an initial DNN. For example, if the UE 108 utilizes separate neural networks for channel estimation and RACH procedures, the CNN management module 118 implements at least one initial neural network 1014 for each of these processes. The initial neural network(s) 1014, in at least some embodiments, is a neural network(s) 1014 having a default architecture, default weights, and default biases. If the initial neural network(s) 1014 is a conditional neural network, the initial neural network(s) is also associated with default execution conditions 134. The BS 110 (or another network component) can preconfigure the UE 108 with the initial neural network(s) 1014. Alternatively, the CNN configuration(s) and condition information message 1008 transmitted by the BS 110 can indicate the initial neural network(s) 1014 to the UE 108.

At block 816, the CNN management module 118 of the UE 108 begins evaluating 1016 (FIG. 10) one or more execution conditions 134 associated with at least one CNN configuration 124. In one example, the CNN management module 118 identifies the execution conditions 134 to monitor based on the CNN condition information 126 received in the CNN configuration(s) and condition information message 1008. In another example, the UE 108 uses one or more indices 302 received from the BS 110 to search the storage structure 200 for the execution condition(s) 134 to monitor.

At block 818, the CNN management module 118 determines if the execution condition(s) 134 has been detected/satisfied. For example, if a CNN configuration 124 indicates the UE 108 is to change CNN architectures based on air interface conditions, the CNN management module 118 determines whether the UE RF conditions are above or below an RF condition threshold. In another example, the execution conditions 134 are related to the serving cell signal power. In this example, the CNN management module 118 monitors for the signal power of the serving cell dropping below a signal power threshold. In yet another example, the CNN management module 118 monitors for multiple execution conditions 134 associated with a given CNN configuration 124. Depending on the CNN configuration 124, the CNN management module 118 determines if any of the multiple execution conditions 134, two or more of the multiple execution conditions 134, or all the multiple execution conditions 134 are detected/satisfied.

If the CNN management module 118 determines that the execution condition(s) 134 has not been detected/satisfied, the CNN management module 118, at block 820, maintains the configuration of the presently implemented neural network, which, in this example, is the initial neural network 1014. However, in other instances, the presently implemented neural network is a CNN 114 previously implemented by the UE 108. At block 822, if the CNN management module 118 determines that the execution condition(s) 134 has been detected/satisfied, the CNN management module 118 determines if the execution condition(s) 134 is associated with timer information 304. As described above with respect to FIG. 3, the BS 110 can associate a CNN configuration 124 with timer information 304. In these embodiments, the CNN management module 118 processes the storage structure 200 to determine if timer information 304 is associated with the CNN configuration(s) 124 corresponding to the detected/satisfied execution condition(s) 134.

At block 824, if the CNN management module 118 determines the CNN configuration(s) 124 is not associated with timer information 304, the CNN management module 118 applies 1024 (FIG. 10) the associated CNN configuration(s) 124. In at least some embodiments, applying a CNN configuration 124 includes updating the neural network 1014 presently implemented at the UE 108 with at least one of different neural network weights or different neural network biases, or switching to a fully (or completely) different neural network architecture (i.e., a different/new CNN 114). To illustrate, consider the example described above in which the CNN management module 118 monitors the RF conditions of the UE 108. In this example, when the CNN management module 118 determines the RF conditions are above an RF condition threshold, the CNN management module 118 switches its presently implemented neural network 1014 to a less complex neural network (according to the corresponding CNN configuration 124) to save power consumption at the UE 108 when performing channel estimation. However, if the CNN management module 118 determines the RF conditions are below the RF condition threshold, the UE switches its presently implemented neural network 1014 to a more complex neural network (according to the corresponding CNN configuration 124) to perform channel estimation. In the other example described above, in which the CNN management module 118 is monitoring execution conditions 134 related to the serving cell signal power, if the CNN management module 118 determines the signal power of the serving cell has dropped below a signal power threshold, the CNN management module 118 applies a CNN configuration 124 that configures the UE 108 to apply an entirely different CNN 144 to search neighboring cells. In this example, the UE 108 implements the new CNN 114 because the neighboring cell implements a particular neural network for pilot and synchronization signals. Stated differently, the new CNN 114 implemented by the UE 108 corresponds to the neural network implemented by the neighboring cell.

In at least some embodiments, the CNN management module 118 determines it has concurrently detected execution conditions 134 associated with different CNN configurations 124 for the same process. In these embodiments, the CNN management module 118 prioritizes one or more of the execution conditions 134 or associated CNN configurations 124. For example, the CNN configurations 124 for the same process can be associated with conflict resolution information, such as a priority list. The CNN management module 118 implements the conflict resolution information to select a given CNN configuration 124 having the highest priority. However, other conflict resolution mechanisms are also applicable.

At block 826, the UE 108 transmits a CNN configuration update message 1026 (FIG. 10) to the BS 110 (or another network component) informing the BS 110 that the UE 108 has implemented a new CNN 114 or changed a configuration of a presently implemented CNN 114. Returning to block 822, if the CNN management module 118 determines that timer information 304 is associated with the CNN configuration(s) 124, the CNN management module 118, at block 828, executes a (hysteresis) timer 1028 (FIG. 10) based on the timer information 304 received from the BS 110. At block 830, the CNN management module 118 determines if the timer 1028 has expired. If the timer has not expired, the CNN management module 118 continues to monitor the timer 1028. However, if the timer 1028 has expired, the process flows to block 826 and the CNN management module 118 applies the associated CNN configuration(s). Stated differently, rather than applying the CNN configuration 124 immediately upon detection/satisfaction of a CNN execution condition(s) 134, the CNN management module 118 delays applying the CNN configuration 124 until after the expiration of the timer 1028. The process continues to block 826, and the UE 108 transmits the CNN configuration update message 1026 to the BS 110 (or another network component).

After (or concurrently with) the CNN management module 118 sending the CNN configuration update message 1026 to the BS 110, the process returns to block 816, and the CNN management module 118 continues to evaluate execution conditions 139 for changing/updating the CNN configurations 124. In at least some embodiments, if an executions condition(s) 134 returns to a previous state, the CNN management module 118 reverts back to a previously implemented CNN 114 or CNN configuration 124. Consider the example described above in which the CNN management module 118 determines if the RF conditions are above or below an RF condition threshold. In this example, if the CNN management module 118 switches its present neural network 1014 to a more complex neural network in response to the RF conditions being below the RF condition threshold but the RF conditions subsequently improve to be above the RF condition threshold, the CNN management module 118 can fall back to the less complex neural network. Alternatively, the CNN management module 118 can fall back to a default CNN configuration. Also, it should be understood that the CNN management module 118 can perform multiple instances of the operations described above with respect to blocks 816 to 830 for different processes. For example, the CNN management module 118 concurrently performs a first instance of the operations for a channel estimation process, a second instance of the operations for a RACH procedure, a third instance of the operations for beam management, and so on.

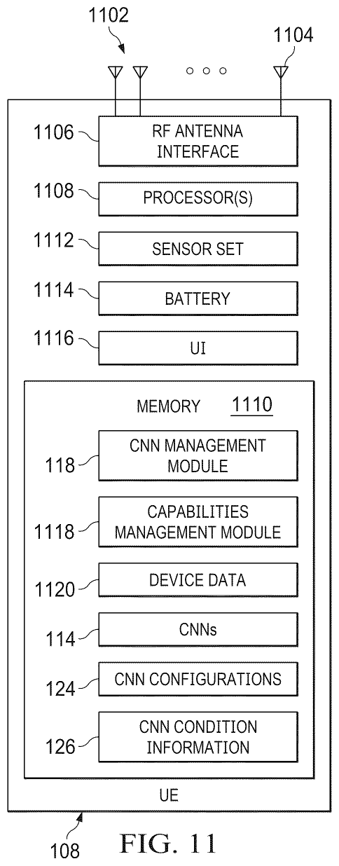

FIG. 11 illustrates example hardware configurations for the UE 108 in accordance with some embodiments. Note that the depicted hardware configuration represents the processing components and communication components most directly related to the neural-network-based processes of one or more embodiments and omits certain components well-understood to be frequently implemented in such electronic devices, such as displays, non-sensor peripherals, external power supplies, and the like.

In the depicted configuration, the UE 108 includes an RF front end 1102 with one or more antennas 1104 and an RF antenna interface 1106 with one or more modems to support one or more RATs. The RF front end 1102 operates, in effect, as a physical (PHY) transceiver interface to conduct and process signaling between one or more processors 1108 of the UE 108 and the antennas 1104 to facilitate various types of wireless communication. The antennas 1104 can be arranged in one or more arrays of multiple antennas configured similar to or different from each other and can be tuned to one or more frequency bands associated with a corresponding RAT. The one or more processors 1108 can include, for example, one or more central processing units (CPUs), graphics processing units (GPUs), tensor processing units (TPUs) or other application-specific integrated circuits (ASIC), and the like. To illustrate, the processors 1108 can include an application processor (AP) utilized by the UE 108 to execute an operating system and various user-level software applications, as well as one or more processors utilized by modems or a baseband processor of the RF front end 1102. The UE 108 further includes one or more computer-readable media 1110 that include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the computer-readable media 1110 is referred to herein as “memory 1110” in view of the frequent use of system memory or other memory to store data and instructions for execution by the processor 1108, but it will be understood that reference to “memory 1110” shall apply equally to other types of storage media unless otherwise noted.

In at least one embodiment, the UE 108 further includes a plurality of sensors, referred to herein as a sensor set 1112, at least some of which are utilized in the neural-network-based schemes of one or more embodiments. Generally, the sensors of the sensor set 1112 include those sensors that sense some aspect of the environment of the UE 108 or the use of the UE 108 by a user which have the potential to sense a parameter that has at least some impact on or reflects, for example, the speed of the UE 108, a location of the UE 108, an orientation of the UE 108, movement, or a combination thereof. The sensors of the sensor set 1112 can include one or more sensors for object detection, such as radar sensors, lidar sensors, imaging sensors, structured-light-based depth sensors, and the like. The sensor set 1112 also can include one or more sensors for determining a position or pose/orientation of the UE 108, such as satellite positioning sensors including Global Positioning System (GPS) sensors, Global Navigation Satellite System (GNSS) sensors, Inertial Measurement Unit (IMU) sensors, visual odometry sensors, gyroscopes, tilt sensors or other inclinometers, ultrawideband (UWB)-based sensors, and the like. Other examples of types of sensors of the sensor set 1112 can include environmental sensors, such as temperature sensors, barometers, altimeters, and the like or imaging sensors, such as cameras for image capture by a user, cameras for facial detection, cameras for stereoscopy or visual odometry, light sensors for detection of objects in proximity to a feature of the device, object detection sensors (e.g., radar sensors, lidar sensors, imaging sensors, or structured-light-based depth sensors), and the like. The UE 108 further can include one or more batteries 1114 or other portable power sources, as well as one or more user interface (UI) components 1116, such as touch screens, user-manipulable input/output devices (e.g., “buttons” or keyboards), or other touch/contact sensors, microphones, or other voice sensors for capturing audio content, image sensors for capturing video content, thermal sensors (such as for detecting proximity to a user), and the like.

The one or more memories 1110 of the UE 108 store one or more sets of executable software instructions and associated data that manipulate the one or more processors 1108 and other components of the UE 108 to perform the various functions attributed to the UE 108. The sets of executable software instructions include, for example, an operating system (OS) and various drivers (not shown), and various software applications. The sets of executable software instructions further include one or more of the CNN management module 118, a capabilities management module 1118, and so. The capabilities management module 1118 determines various capabilities of the UE 108 that pertain to neural network configuration or selection and reports such capabilities to the BS 110 or managing component 120, as well as monitors the UE 108 for changes in such capabilities, including changes in RF and processing capabilities, changes in accessory availability or capability, changes in sensor availability, and the like, and manages the reporting of such capabilities, and changes in the capabilities, to the BS 110 or managing component 120.

To facilitate the operations of the UE 108, the one or more memories 1110 of the UE 108 further can store data associated with these operations. This data can include, for example, device data 1120, CNNs 114, CNN configurations 124, CNN condition information 126, and so on. The device data 1120 represents, for example, user data, multimedia data, beamforming codebooks, software application configuration information, and the like. The device data 1120 further can include capability information for the UE 108, such as sensor capability information regarding the one or more sensors of the sensor set 1112, including the presence or absence of a particular sensor or sensor type, and, for those sensors present, one or more representations of their corresponding capabilities, such as range and resolution for lidar or radar sensors, image resolution and color depth for imaging cameras, and the like. The capability information further can include information regarding, for example, the capabilities or status of the battery 1114, the capabilities or status of the UI 1116 (e.g., screen resolution, color gamut, or frame rate for a display), and the like.

The CNN configurations 124 represent UE-implemented examples selected from the set of candidate CNN configurations 1324 maintained by the managing component 120. Each CNN configuration 124 includes one or more data structures containing data and other information representative of a corresponding architecture and/or parameter configurations used by the CNN management module 118 to form a corresponding CNN 114 of the UE 108. The information included in a CNN configuration 124 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the CNN 114, coefficients (e.g., weights and biases) utilized by the CNN 114, kernel parameters, a number of filters utilized by the CNN 114, strides/pooling configurations utilized by the CNN 114, an activation function of each neural network layer, interconnections between neural network layers, neural network layers to skip, and so on. Accordingly, the CNN configurations 124 includes any combination of neural network formation configuration elements (e.g., architecture and/or parameter configurations) for creating a neural network formation configuration (e.g., a combination of one or more neural network formation configuration elements) that defines and/or forms a CNN 114. As described above with respect to FIG. 1, the CNN condition information 126 includes execution condition(s) 134 associated with one or more CNN configurations 124 that act as a trigger for the CNN management module 118 to apply the corresponding CNN configuration(s) information 124.

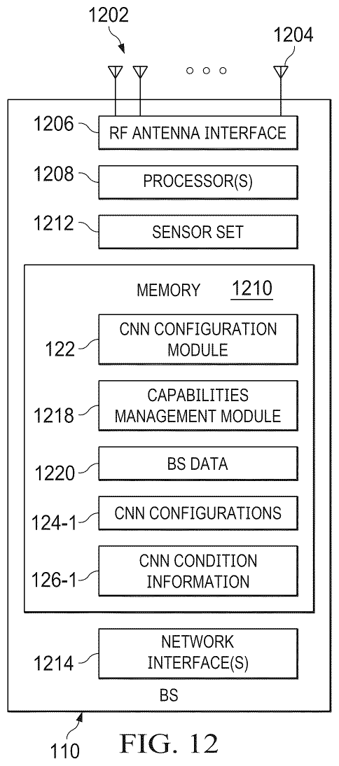

FIG. 12 illustrates example hardware configurations for the BS 110 in accordance with some embodiments. Note that the depicted hardware configuration represents the processing components and communication components most directly related to the neural-network-based processes of one or more embodiments and omits certain components well-understood to be frequently implemented in such electronic devices, such as displays, non-sensor peripherals, external power supplies, and the like. Further note that although the illustrated diagram represents an implementation of the BS 110 as a single network node (e.g., a 5G NR Node B, or “gNB”), the functionality, and thus the hardware components, of the BS 110 instead can be distributed across multiple network nodes or devices and can be distributed in a manner to perform the functions of one or more embodiments.

In the depicted configuration, the BS 110 includes an RF front end 1202 having one or more antennas 1204 and an RF antenna interface (or front end) 1206 having one or more modems to support one or more RATs and which operates as a PHY transceiver interface to conduct and process signaling between one or more processors 1208 of the BS 110 and the antennas 1204 to facilitate various types of wireless communication. The antennas 1204 can be arranged in one or more arrays of multiple antennas configured similar to or different from each other and can be tuned to one or more frequency bands associated with a corresponding RAT. The one or more processors 1208 can include, for example, one or more CPUs, GPUS, TPUs or other ASICs, and the like. The BS 110 further includes one or more computer-readable media 1210 that include any of a variety of media used by electronic devices to store data and/or executable instructions, such as RAM, ROM, caches, Flash memory, SSD or other mass-storage devices, and the like. As with the memory 1210 of the UE 108, for ease of illustration and brevity, the computer-readable media 1210 is referred to herein as “memory 1210” in view of the frequent use of system memory or other memory to store data and instructions for execution by the processor 1208, but it will be understood that reference to “memory 1210” shall apply equally to other types of storage media unless otherwise noted.

The BS also includes one or more network interfaces 1214 to the core network 104, other BSs, and so on. In at least one embodiment, the BS 110 further includes a plurality of sensors, referred to herein as a sensor set 1212, at least some of which are utilized in the neural-network-based schemes of one or more embodiments. Generally, the sensors of the sensor set 1212 include those sensors that sense some aspect of the environment of the BS 110 and which have the potential to sense a parameter that has at least some impact on or reflects an RF propagation path or RF transmission/reception performance by the BS 110 relative to the corresponding UE 108. The sensors of the sensor set 1212 can include one or more sensors for object detection, such as radar sensors, lidar sensors, imaging sensors, structured-light-based depth sensors, and the like. If the BS 110 is a mobile BS, the sensor set 1212 also can include one or more sensors for determining a position or pose/orientation of the BS 110. Other examples of types of sensors of the sensor set 1212 can include imaging sensors, light sensors for detecting objects in proximity to a feature of the BS 110, and the like.

The one or more memories 1210 of the BS 110 store one or more sets of executable software instructions and associated data that manipulate the one or more processors 1208 and other components of the BS 110 to perform the various functions of one or more embodiments and attributed to the BS 110. The sets of executable software instructions include, for example, an OS and various drivers (not shown) and various software applications. The sets of executable software instructions further include one or more of the CNN configuration module 122, a capabilities management module 1218, and so on.

The capabilities management module 1218 determines various capabilities of the BS 110 that, in at least some embodiments, pertain to neural network configuration or selection and reports such capabilities to the managing component 120, as well as monitors the BS 110 for changes in such capabilities, including changes in RF and processing capabilities, and the like, and manages the reporting of such capabilities, and changes in the capabilities, to the managing component 120.

To facilitate the operations of the BS 110, the one or more memories 1210 of the BS 110 further can store data associated with these operations. This data can include, for example, BS data 1220, CNN configurations 124-1, CNN condition information 126-1, and so on. The BS data 1220 represents, for example, beamforming codebooks, software application configuration information, and the like. The BS data 1220 further can include capability information for the BS 110, such as sensor capability information regarding the one or more sensors of the sensor set 1212, including the presence or absence of a particular sensor or sensor type, and, for those sensors present, one or more representations of their corresponding capabilities, such as range and resolution for lidar or radar sensors, image resolution and color depth for imaging cameras, and the like. The CNN configurations 124-1 and CNN condition information 126-1 have been described above.

FIG. 13 illustrates an example hardware configuration for the managing component 120 in accordance with some embodiments. Note that the depicted hardware configuration represents the processing components and communication components most directly related to the neural-network-based processes of one or more embodiments and omits certain components well-understood to be frequently implemented in such electronic devices. Further, although the hardware configuration is depicted as being located at a single component, the functionality, and thus the hardware components, of the managing component 120 instead can be distributed across multiple infrastructure components or nodes and can be distributed in a manner to perform the functions of one or more embodiments.

As noted above, any of a variety of components, or a combination of components, within the network infrastructure 102 can implement the managing component 120. For ease of illustration, the managing component 120 is described with reference to an example implementation as a server or another component in one of the core networks 104, but in other embodiments, the managing component 120 is implemented as, for example, part of a BS 110.

As shown, the managing component 120 includes one or more network interfaces 1302 (e.g., an Ethernet interface) to couple to one or more networks of the wireless communication system 100, one or more processors 1304 coupled to the one or more network interfaces 1302, and one or more non-transitory computer-readable storage media 1306 (referred to herein as a “memory 1306” for brevity) coupled to the one or more processors 1304. The one or more memories 1306 stores one or more sets of executable software instructions and associated data that manipulate the one or more processors 1304 and other components of the managing component 120 to perform the various functions of one or more embodiments and attributed to the managing component 120. The sets of executable software instructions include, for example, an OS and various drivers (not shown).

The software stored in the one or more memories 1306 further can include one or more of a training module 1308, the CNN configuration module 1322, and so on. The training module 1308 operates to manage the individual training and joint training of CNN configurations 124-2 for the set of candidate CNN configurations 1324 to be employed at the UE 108 using one or more sets of training data 1310. The training can include training neural networks while offline (that is, while not actively engaged in processing the communications) and/or online (that is, while actively engaged in processing the communications). For example, the training module 1308 can individually or jointly train a CNN configuration 124-2 selected by the managing component 120 using one or more sets of training data to provide corresponding functionality. The offline or online training processes can implement different parameters for different execution conditions 134. For example, if the training module 1308 is training a candidate CNN configuration 124-2 for a RACH process, examples of the different execution conditions 134 include initial RRC connection setup, RRC connection re-establishment, handover, downlink data arrival, uplink data arrival, scheduling request failure, New Radio (NR) cell addition for dual connectivity, beam recovery, and so on. The training module 1308 can implement one or both of offline or online training. Moreover, the training can be individual or separate, such that each CNN is individually trained on its own training data set without the result being communicated to, or otherwise influencing, other CNNs. Alternatively, the training can be joint training, such that two or more CNNs are jointly trained on the same, or complementary, data sets.

The CNN configuration module 1322 operates to obtain, filter, and otherwise process selection-relevant information 1312 from the UE 108 and uses this selection-relevant information 1312 to select an individual or a pair of jointly trained CNN configurations 124-2 from the candidate set of CNN configurations 1324 for implementation at the UE 108. As noted above, this selection-relevant information 1312 can include, for example, one or more of UE (or BS) capability information 1314, present propagation path information, channel-specific parameters, and the like. After the CNN configuration module 1322 has made a selection, the CNN configuration module 1322 then initiates the transmission of an indication of the selected CNN configurations 124-2 and associated CNN condition information 126-2 to the UE 108, such as via transmission of an index number associated with the selected configuration, transmission of one or more data structures representative of the CNN configuration itself, or a combination thereof.

The present disclosure may be further understood by considering the following examples, individually or in various combinations:

Example 1: A computer-implemented method, in a user equipment (UE) of a cellular communication system, including: obtaining a first conditional neural network configuration and a first conditional neural network execution condition; monitoring for the first conditional neural network execution condition; responsive to determining the first conditional neural network execution condition has been satisfied, configuring, based on the first conditional neural network configuration, a first neural network implemented at the UE; and performing a first set of wireless communication operations using the configured first neural network.

Example 2: The computer-implemented method of Example 1, further including: obtaining a second conditional neural network configuration and a second conditional neural network execution condition; monitoring for the second conditional neural network execution condition; responsive to determining the second conditional neural network execution condition has been satisfied, configuring, based on the second conditional neural network configuration, a second neural network implemented at the UE; and performing a second set of wireless communication operations using the configured second neural network, wherein the second set of wireless communication operations is different from the first set of wireless communication operations.

Example 3: The computer-implemented method of Example 2, further including: implementing the configured second neural network concurrently with the configured first neural network.

Example 4: The computer-implemented method of Example 2 or 3, wherein configuring the second neural network includes configuring at least one of an architecture of the second neural network, one or more weights of the second neural network, or one or more biases of the second neural network.

Example 5: The computer-implemented method of any one of Examples 2 to 4, wherein the first set of wireless communication operations and the second set of wireless communication operations each includes one or more of: channel estimation; cell measurement; beam management; signal modulation; signal demodulation; Random Access Channel procedures; data streaming; or UE positioning.

Example 6: The computer-implemented method of any one of the preceding Examples, further including: wherein the first conditional neural network execution condition includes two or more operating conditions.

Example 7: The computer-implemented method of any one of the preceding Examples, wherein obtaining the first conditional neural network configuration includes: receiving, from a network component of the cellular communication system, an index associated with the first conditional neural network configuration; and obtaining the first conditional neural network configuration from a storage structure using the index.

Example 8: The computer-implemented method of any one of the preceding Examples, wherein the first conditional neural network configuration is obtained from a network component of the cellular communication system.

Example 9: The computer-implemented method of Example 8, wherein obtaining the first conditional neural network configuration includes: receiving, from the network component of the cellular communication system, a Radio Resource Control (RRC) message including the first conditional neural network configuration.

Example 10: The computer-implemented method of Example 8, wherein obtaining the first conditional neural network configuration includes: receiving, from the network component of the cellular communication system, a System Information Block (SIB) message including the first conditional neural network configuration.

Example 11: The computer-implemented method of any one of the preceding Examples, wherein configuring the first neural network includes:
executing a timer based on timer information received from a network component of the cellular communication system; and responsive to the timer expiring, configuring the first neural network based on the first conditional neural network configuration.

Example 12: The computer-implemented method of any one of the preceding Examples, wherein configuring the first neural network includes configuring at least one of an architecture of the first neural network, one or more weights of the first neural network, or one or more biases of the first neural network.

Example 13: The computer-implemented method of any one of Examples 1 to 11, wherein configuring the first neural network includes maintaining a presently implemented neural network architecture of the first neural network and changing one or more weights of the first neural network or one or more biases of the first neural network.

Example 14: The computer-implemented method of any one of Examples 1 to 11, wherein configuring the first neural network includes changing a presently implemented neural network architecture of the first neural network and maintaining at least one of one or more presently implemented weights of the first neural network or one or more presently implemented biases of the first neural network.

Example 15: The computer-implemented method of any one of the preceding Examples, wherein the first conditional neural network execution condition includes an air interface condition.

Example 16: The computer-implemented method of any one of the preceding Examples, wherein the first conditional neural network execution condition includes a UE operating condition.

Example 17: The computer-implemented method of any one of the preceding Examples, wherein the first neural network is a deep neural network (DNN).

Example 21: A device including: a radio frequency (RF) antenna interface; at least one processor coupled to the RF antenna interface; and a memory storing executable instructions, the executable instructions configured to manipulate the at least one processor to perform the method of any of Examples 1 to 20.

Example 22: A computer-implemented method, in a managing infrastructure component of a cellular communication system, including: transmitting a conditional neural network configuration to a user equipment (UE) of the cellular communication system; and transmitting a set of conditional neural network execution conditions to the UE.

Example 23: The computer-implemented method of Example 22, wherein transmitting the conditional neural network configuration includes: transmitting the conditional neural network configuration to the UE in a Radio Resource Control (RRC) message.

Example 24: The computer-implemented method of any one of Example 22 or Example 23, wherein transmitting the conditional neural network configuration includes: transmitting the conditional neural network configuration to the UE in a System Information Block (SIB) message.

Example 25: The computer-implemented method of any one of Examples 22 to 24, wherein transmitting the set of conditional neural network execution conditions includes: transmitting the set of conditional neural network execution conditions to the UE in a Radio Resource Control (RRC) message.

Example 26: The computer-implemented method of any one of Examples 22 to 25, wherein transmitting the conditional neural network configuration includes: transmitting the set of conditional neural network execution conditions to the UE in a System Information Block (SIB) message.

Example 27: The computer-implemented method of Example 22, wherein the set of conditional neural network execution conditions is transmitted as part of the conditional neural network configuration.

Example 28: The computer-implemented method of Example 22, further including: transmitting timer information associated with the conditional neural network configuration to the UE, wherein the timer information configures the UE to implement a timer and apply the conditional neural network configuration responsive to the set of conditional neural network execution conditions being satisfied for a duration of the timer, and otherwise maintain an initial conditional neural network configuration.

Example 29: The computer-implemented method of any one of Examples 22 to 28, wherein the conditional neural network configuration includes at least one of a neural network architecture, one or more neural network weights, or one or more neural network architecture biases to be applied by the UE.

Example 30: The computer-implemented method of any one of Examples 22 to 29, wherein the conditional neural network configuration configures the UE to maintain a presently implemented neural network architecture of a neural network and change at least one of one or more weights of the neural network or one or more biases of the neural network.

Example 31: The computer-implemented method of any one of Examples 22 to 29, wherein the conditional neural network configuration configures the UE to change a presently implemented neural network architecture a neural network and maintain at least one of one or more presently implemented weights of the neural network or one or more presently implemented biases of the neural network.

Example 32: The computer-implemented method of any one of Examples 22 to 31, wherein the managing infrastructure component is a base station.

Example 33: The computer-implemented method of any one of Examples 22 to 32, further including: receive a capabilities message indicating one or more capabilities of the UE; and responsive to the capabilities message having been received, transmitting at least one of an updated conditional neural network configuration or an updated set of conditional neural network execution conditions to the UE.

Example 34: A device including: a network interface; at least one processor coupled to the network interface; and a memory storing executable instructions, the executable instructions configured to manipulate the at least one processor to perform the method of any of Examples 22 to 32.

In at least some embodiments, certain aspects of the techniques described above can be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium can be in source code, assembly language code, object code, or another instruction format that is interpreted or otherwise executable by one or more processors.

A computer-readable storage medium can include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium can be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device can not be required, and that one or more further activities can be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims. Moreover, the particular embodiments disclosed above are illustrative only, as the disclosed subject matter can be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above can be altered or modified and all such variations are considered within the scope of the disclosed subject matter. Accordingly, the protection sought herein is as set forth in the claims below.

1. A computer-implemented method, in a user equipment (UE) of a cellular communication system, comprising:
obtaining a first conditional neural network configuration and a first conditional neural network execution condition;
monitoring for the first conditional neural network execution condition;
responsive to determining the first conditional neural network execution condition has been satisfied, configuring, based on the first conditional neural network configuration, a first neural network implemented at the UE; and
performing a first set of wireless communication operations using the configured first neural network.

2. The computer-implemented method of claim 1, further comprising:
obtaining a second conditional neural network configuration and a second conditional neural network execution condition;
monitoring for the second conditional neural network execution condition;
responsive to determining the second conditional neural network execution condition has been satisfied, configuring, based on the second conditional neural network configuration, a second neural network implemented at the UE; and
performing a second set of wireless communication operations using the configured second neural network, wherein the second set of wireless communication operations is different from the first set of wireless communication operations.

3. The computer-implemented method of claim 2, further comprising:
implementing the configured second neural network concurrently with the configured first neural network.

4. (canceled)

5. The computer-implemented method of claim 2, wherein the first set of wireless communication operations and the second set of wireless communication operations each comprises one or more of:
channel estimation;
cell measurement;
beam management;
signal modulation;
signal demodulation;
Random Access Channel procedures;
data streaming; or
UE positioning.

6. The computer-implemented method of claim 1, further comprising:
wherein the first conditional neural network execution condition includes two or more operating conditions.

7. The computer-implemented method of claim 1, wherein obtaining the first conditional neural network configuration comprises:
receiving, from a network component of the cellular communication system, an index associated with the first conditional neural network configuration; and
obtaining the first conditional neural network configuration from a storage structure using the index.

8. The computer-implemented method of claim 1, wherein the first conditional neural network configuration is obtained from a network component of the cellular communication system.

9. The computer-implemented method of claim 8, wherein obtaining the first conditional neural network configuration comprises one of:
receiving, from the network component of the cellular communication system, a Radio Resource Control (RRC) message comprising the first conditional neural network configuration; or
receiving, from the network component of the cellular communication system, a System Information Block (SIB) message comprising the first conditional neural network configuration.

10. (canceled)

11. The computer-implemented method of claim 1, wherein configuring the first neural network comprises:
executing a timer based on timer information received from a network component of the cellular communication system; and
responsive to the timer expiring, configuring the first neural network based on the first conditional neural network configuration.

12. (canceled)

13. The computer-implemented method of claim 1, wherein configuring the first neural network comprises one of:
maintaining a presently implemented neural network architecture of the first neural network and changing one or more weights of the first neural network or one or more biases of the first neural network; or
changing a presently implemented neural network architecture of the first neural network and maintaining at least one of one or more presently implemented weights of the first neural network or one or more presently implemented biases of the first neural network.

14. (canceled)

15. The computer-implemented method of claim 1, wherein the first conditional neural network execution condition comprises at least one of: an air interface condition; or a UE operating condition.

16. (canceled)

17. (canceled)

18. A device comprising:
a radio frequency (RF) antenna interface;
at least one processor coupled to the RF antenna interface; and
a memory storing executable instructions, the executable instructions configured to manipulate the at least one processor to perform the method of claim 1.

19. A computer-implemented method, in a managing infrastructure component of a cellular communication system, comprising:
transmitting a conditional neural network configuration to a user equipment (UE) of the cellular communication system; and
transmitting a set of conditional neural network execution conditions to the UE.

20. The computer-implemented method of claim 19, wherein transmitting the conditional neural network configuration comprises at least one of:
transmitting the conditional neural network configuration to the UE in a Radio Resource Control (RRC) message; or
transmitting the conditional neural network configuration to the UE in a System Information Block (SIB) message.

21. (canceled)

22. The computer-implemented method of claim 19, wherein transmitting the set of conditional neural network execution conditions comprises:
transmitting the set of conditional neural network execution conditions to the UE in a Radio Resource Control (RRC) message.

23. The computer-implemented method of claim 19, wherein transmitting the conditional neural network configuration comprises:
transmitting the set of conditional neural network execution conditions to the UE in a System Information Block (SIB) message.

24. The computer-implemented method of claim 19, wherein the set of conditional neural network execution conditions is transmitted as part of the conditional neural network configuration.

25. The computer-implemented method of claim 19, further comprising:
transmitting timer information associated with the conditional neural network configuration to the UE, wherein the timer information configures the UE to implement a timer and apply the conditional neural network configuration responsive to the set of conditional neural network execution conditions being satisfied for a duration of the timer, and otherwise maintain an initial conditional neural network configuration.

26. The computer-implemented method of claim 19, wherein the conditional neural network configuration comprises at least one of a neural network architecture, one or more neural network weights, or one or more neural network architecture biases to be applied by the UE.

27. The computer-implemented method of claim 19, wherein the conditional neural network configuration configures the UE to one of:
maintain a presently implemented neural network architecture of a neural network and change at least one of one or more weights of the neural network or one or more biases of the neural network; or
change a presently implemented neural network architecture a neural network and maintain at least one of one or more presently implemented weights of the neural network or one or more presently implemented biases of the neural network.

28. (canceled)

29. (canceled)

30. The computer-implemented method of claim 19, further comprising:
receive a capabilities message indicating one or more capabilities of the UE; and
responsive to the capabilities message having been received, transmitting at least one of an updated conditional neural network configuration or an updated set of conditional neural network execution conditions to the UE.

31. A device comprising:
a network interface;
at least one processor coupled to the network interface; and
a memory storing executable instructions, the executable instructions configured to manipulate the at least one processor to perform the method of claim 19.
